(19) United States
(12) Patent Application Publication
(10) Pub. No.: US 2011/0314634 A1
(43) Pub. Date: Dec. 29, 2011

(54) Drive System for Driving and for Guiding a Wall Element for a Room Partition System

(75) Inventors: Arne Liebscher, Herdecke (DE); Olaf Lüttmann, Bad Zwischenahn (DE); Harald Hoopmann, Westerstede (DE)

(73) Assignee: Dorma GmbH + Co. KG, Ennepetal (DE)

(21) Appl. No.: 13/255,798

(22) PCT Filed: Feb. 26, 2010
(86) PCT No.: PCT/EP2010/001209

§ 371 Date: Sep. 9, 2011

(30) Foreign Application Priority Data
Mar. 10, 2009 (DE) 10 2009 011 947.7

(51) Int. Cl. E05F 11/02; E05D 15/06

(52) U.S. Cl. 16/91

(57) ABSTRACT

A drive system for operating and for guiding a wall element, in particular for a room partitioning wall system, with a carriage unit, which is guided to be longitudinally movable in a guiding rail (3). The wall element is pivotably attached to the carriage unit.

### CROSS REFERENCE TO RELATED APPLICATIONS

This is a U.S. national stage of application No. PCT/EP2010/001209, filed on Feb. 26, 2010. Priority is claimed on German Application No. 10 2009 011 947.7, filed Mar. 10, 2009, the content of which are incorporated here by reference.

### BACKGROUND OF THE INVENTION

1. Field of the Invention

The present invention relates to a drive system for driving and for guiding a wall element for a room partitioning wall system with a carriage unit guided to be longitudinally movable in a guiding rail, wherein the carriage unit has a roller carriage and a drive unit.

2. Description of Related Art

Drive systems for driving and for guiding a wall element for room partitioning wall systems are well known. The drive systems have carriage units with respective drives such that the carriage units are autonomously displaceable in the guiding rail. For this purpose, carriage units are known in different configurations that have a roller carriage located within the guiding rail, wherein a drive unit is affixed to said carriage in which unit at least the drive motor, and optionally a gear system, are accommodated.

If a ceiling track is not mounted straight, if the ceilings are not horizontal, when traveling over branches, or when displacing the wall elements, an oscillating motion is introduced into the system consisting of roller carriage—suspension—wall element, which results in a bending load on the suspension system. The roller carriages are therefore unilaterally loaded and they travel with only one roller side in the ceiling track. The unilateral load may result in canting of the roller carriage in the ceiling track, which leads to malfunctioning of the entire sliding wall. The unilateral load may likewise result in increased load on the guiding rollers, whereby, in the extreme case, the drive forces are exceeded and the system comes to a stop when traveling. However, when the roller carriage cants, it may happen that one roller lifts off and thus no torque is transferred, which again results in malfunctioning of the system.

A drive system for driving and for guiding a wall element for a room partitioning wall system is disclosed in EP 0 959 219 A2. A carriage unit is provided therein which is accommodated to be longitudinally movable in the guiding rail via rollers, wherein the rollers are driven via a drive unit. Guiding rollers are provided to allow for guiding the carriage unit within the guiding rail and in particular in branchings of several guiding rails, wherein said guiding rollers are guided on the upper side of the roller carriage of the carriage unit in pre-established guiding paths within the guiding rail. If the roller rail is mounted oblique, the carrying bolts are loaded by an additional bending force and the guiding rollers need to transfer an extreme surface pressure, which might exceed the driving forces.

From the document DE 199 32 891 A1, a drive system of a carriage unit for a room partitioning wall system is known, which has several guiding rollers and requires further guiding devices within the guiding rail that cooperate with the guiding millers. During an oscillating movement of the sliding wall caused by a non-horizontal ceiling track, this roller carriage does not cant in the slot of the roller rail; however, the load on the guiding rollers becomes so high that the drive forces may not be sufficient any more and, while being displaced, the sliding wall stops.

### SUMMARY OF THE INVENTION

It is an object of the present invention to provide a drive system for driving and for guiding a wall element for a room partitioning wall system that compensates for lateral forces generated by an oscillating movement.

One embodiment of invention includes a pivotable arrangement of the wall element at the carriage unit that excludes malfunction, which might occur on account of possible canting of the roller carriage in the guiding rail or on account of a too large mechanical load on the guiding rollers. Mounting the guiding rail at the ceiling is therefore less complicated, because it is possible to work with more important tolerances. Likewise, installing the guiding rails at inherently oblique ceiling structures becomes easier, because the compensating sub-structures can be foregone. The pivoting capacity of the wall element in relation to the carriage unit ensures that, at any time, both rollers rest in the guiding rail and absorb constant portions of the wall element weight. The non-positive connection is thereby guaranteed in any operational situation.

In a preferred embodiment, the wall element is suspended at or in the roller carriage via an articulation such that the wall element is free to laterally oscillate to a certain degree without having any consequences for the drive system in the guiding rail. In this case, the center of rotation should be located as close as possible to the roller carriage shaft to avoid canting of the carriage.

A sheet metal support is disposed between the wall element and the articulation in the roller carriage. The drive system can be modularly configured in that the motor and a gearing stage are disposed at the sheet metal support so that only the roller carriage runs in the guiding rail. In a preferred embodiment, the drive unit is disposed in this case underneath the roller carriage. This allows for easy maintenance, because neither the wall element nor the guiding rail need to be uninstalled for exchanging the motor and the gear system.

By disposing a guiding device between the roller carriage and the drive unit, the slot, existing in the guiding rail, is utilized in a very space-saving manner. Thereby, the overall system becomes less expensive, because no running surfaces for guiding rollers are required within the guiding rail.

Advantageously, the guiding device has at least one, and preferably two guiding rollers, which, for the purpose of guiding the carriage unit, roll on guiding surfaces that laterally adjoin the guiding device. If the guiding device has two guiding rollers, the roller carriage is guided in the longitudinal direction of the guiding rail. If the guiding rail has a curvature or if the carriage unit passes through a branching, the roller carriage is able to follow the path of the guiding rail, because it is guided by the two guiding rollers. The guiding rollers roll on the guiding surfaces that are configured at the guiding rail and located in the lower area. The guiding rail forms a box-shaped hollow profile with a C-shaped cross-section and consequently with an opening on the underside, through which the guiding device extends. The carriage unit is rotatably disposed at the wall element, wherein the wall element may be guided by two carriage units in the guiding rail, one of said carriage units being driven. The second carriage unit simply serves for the purpose of guiding the wall element within the guiding rail without having a driving function. Therefore, the carriage units are rotatably disposed at the wall element such that the roller carriage can follow the curved path of the guiding rail. If the carriage unit passes a turnout, elements cooperating with the guiding device are required such that the displacement direction of the carriage unit corresponds to the desired direction. At the location of the turnout, the guiding rails may have flap elements for this purpose, which, like a rail turnout, pre-determine the direction for the carriage unit to follow.

Another very space-saving improvement is achieved if the guiding rollers are rotatably disposed on the bolts, which connect the sheet metal support to the articulation. In a preferred embodiment, two guiding rollers, disposed vertically one above the other, are mounted to each bolt. This arrangement prevents canting within the slot of the guiding rail, because the bolts do not only rotate about the articulation during a lateral deflection of the wall element, but they also bent, because a portion of the guiding rollers bears against the guiding surface. Disposing two independent guiding rollers one above the other optimizes the running properties, if, in the event of canting, the guiding rollers move in opposite directions of rotation, if the guiding rollers bear against different guiding surfaces.

The articulation may be disposed directly in or at the roller carriage or be supported within an insert, as it is already known for example with friction bearings or ball-and-socket joints.

The guiding rail is affixed to the ceiling of a room, wherein the drive motor extends in vertical direction underneath the guiding rail and, together with an electrical unit, is accommodated in a sheet metal support. The vertical direction of extension of the drive motor corresponds to the arrangement of the axis of rotation of the motor shaft such that the latter is located within the guiding rail and vertical to the direction of movement of the roller carriage. The drive motor essentially has a cylindrically shaped basic structure, around which the sheet metal support extends. However, the sheet metal support is configured to be bent in a U-shape and provided with a U-opening disposed vertically and downward oriented. In addition to the drive motor, in the U-shaped sheet metal support, furthermore an electrical unit is disposed adjacent to the drive motor and is affixed to the sheet metal support.

For driving the roller carriage, different gearing concepts may be provided, in order to drive the roller carriage disposed above the guiding device, by the drive motor disposed underneath the guiding device.

A possible gearing concept between the drive motor and the roller carriage comprises a cylindrical gear system, wherein the drive motor is laterally offset with regard to the drive shaft. The proper drive motor may be attached to the housing of the cylindrical gear system, wherein the cylindrical gear system and the drive motor may likewise form one mechanical unit.

Advantageously, the cylindrical gear system represents a first gearing stage between the drive motor and the roller carriage, wherein an angular gear system is disposed between the drive shaft and the roller carriage shaft in order to form a second gearing stage. The angular gear system allows for a limited pivoting capacity within the tooth geometry, if the center of rotation is located close to the pitch circle plane. The angular gear system may be configured as crown toothing, as bevel gear toothing, or as another toothing, in order to transmit the rotational movement of the vertically extending drive shaft to the horizontally extending roller carriage shaft disposed transversely to the displacement direction of the roller carriage within the guiding rail. Rollers are supported on the outside of the roller carriage shaft, at least one of said rollers being driven by the drive motor. Furthermore, the roller carriage may have a roller carriage shaft with two rollers, wherein one of the rollers is driven on one side of the roller carriage and the second roller, disposed on the opposite side, is supported to be freely moving. Two embodiments of the roller carriage are thus illustrated, wherein a first embodiment has two rollers on one roller carriage shaft, only one of said rollers being driven. The roller located on the opposite side is freely rotatable in this case. The second embodiment of the roller carriage has two roller carriage shafts, which respectively accommodate two rollers. In this case, two rollers on one side of the roller carriage are driven, whereas the other two rollers, located on the opposite side, are supported to be freely moving. This configuration prevents the roller carriage from following a straight-line motion, if the guiding rail is curved. On account of unilaterally driven rollers, the roller carriage is able to follow a curvature in the guiding rail without the roller carriage experiencing any jamming or canting in the guiding rail. As an alternative, all four rollers may be driven, wherein the roller carriage shaft has a differential in order to compensate for the difference of rotation speed of a roller located on the inside of a curvature, compared to a roller located on the outside.

Another improvement is achieved in that a pivotable coupling is disposed between the electric motor and the angular gear.

The coupling may be configured as a universal rotary joint, which allows for pivoting the wall element including the drive unit, disposed at the sheet metal support, in relation to the roller carriage by for example ±5° towards the perpendicular line. As described in the embodiment, the configuration of the coupling by coupling shaft, upper coupling part and lower coupling part likewise allows for axial length compensation. As an alternative, a flexible shaft may be inserted between the drive unit and the angular gear.

In the present case, a drive system with a carriage unit is provided which, based on its basic structure consisting of a roller carriage, guiding device and drive unit, allows for a plurality of embodiments. In particular several gearing types should be mentioned for transmitting the driving force of the drive motor to the roller carriage shaft.

If, as an angular gear, a bevel gear toothing is provided between the drive shaft and the roller carriage shaft, the drive shaft may also drive two roller carriage shafts, in that one bevel wheel on the drive shaft drives a bevel wheel on a roller carriage shaft and the second roller carriage shaft is driven by an interconnected intermediate shaft.

### BRIEF DESCRIPTION OF THE DRAWINGS

Hereinafter, further measures enhancing the invention will be illustrated in detail in conjunction with the description of one preferred embodiment of the invention based on the Figures, in which:

FIG. 1: is an embodiment of an inventive drive system for driving and for guiding a wall element by means of an inventive carriage unit;

FIG. 2: is a sectional view of the carriage unit through the guiding unit; and

FIG. 3: is a sectional view of the carriage unit through the driving train.

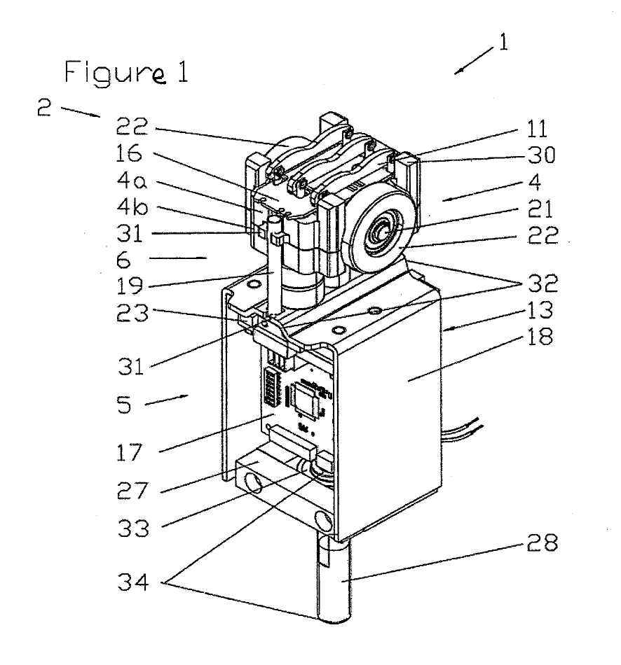

FIG. 1 shows an embodiment of a drive system 1 according to one embodiment of the present invention. The drive system 1 serves for driving and for guiding a wall element, which is in particular utilized in room partitioning wall systems. The wall element may be mounted to a carriage unit 2, wherein the carriage unit 2 is guided to be longitudinally movable within a guiding rail 3. According to the present invention, the carriage unit 2 is subdivided into a roller carriage 4, which is located in the box-shaped hollow space of the guiding rail 3. For driving the roller carriage 4, a drive unit 5, which comprises at least one drive motor 13, is provided underneath the guiding rail 3. A guiding device 6 is disposed between the roller carriage 4 and the drive unit 5. Consequently, the guiding device 6 extends between the roller carriage 4 and the drive unit 5, wherein the mechanical connection between the roller carriage 4 and the drive unit 5 is simultaneously formed by the guiding device 6.

The guiding device 6 has at least one guiding roller 7 guided at both, the left side and the right side by guiding surfaces 8. These surfaces are configured at the guiding rail 3 and form a sort of a longitudinal slot, which extends in the running direction of the guiding rail 3. The guiding surfaces 8 are formed by the flanks of the longitudinal slot, the guiding roller 7 being able to roll on either the left side or the right side thereof. As a result, a carriage unit 2 is proposed, which has a space-saving and advantageous guiding device 6 utilizing at the same time an existing cross-sectional shape of a guiding rail 3 in that guiding surfaces 8 are affixed thereto.

On the upper side, the roller carriage 4 has current collectors 11 which are in contact with respective power rails 12. The power rails 12 are accommodated in the top side of the guiding rail 3 via insulators. When the carriage unit 2 is displaced within the guiding rail 3, a permanent current contact and/or signal contact is guaranteed between the carriage unit 2 and the stationarily inserted power rails 12.

The roller carriage 4 has an upper roller carriage member 4a and a lower roller carriage member 4b, wherein abutment surfaces 30 are provided at the upper roller carriage member 4a in order to limit canting or lifting of the carriage unit 2 within the guiding rail, in that the abutment surface 30 comes to abut against the inner side of the guiding rail.

The roller carriage 4 has one or two roller carriage shafts 21, wherein, according to the illustrated embodiment, two rollers 22 are rotatably accommodated on the roller carriage shaft 21. In this case, one of the two rollers 22 can be driven by a drive motor 13. The drive is realized via a gear, for example a cylindrical gear system 23, and both the drive motor 13 and the gear are accommodated in the drive unit 5.

Essentially, the drive unit 5 includes a sheet metal support 18, in which the drive motor 13 and a second electrical unit 17 are accommodated. An electrical connection 19 affixed to both the roller carriage 4 and the sheet metal support 18 at the carriage unit 2 via attachment points 31, extends between the first electrical unit 16 on the roller carriage 4 and the second electrical unit 17 within the drive unit 5.

In lateral direction, which corresponds to the displacement direction of the carriage unit 2, the sheet metal support 18 is executed with mechanical abutments 32 that form a respective projection in the displacement direction. The sheet metal support 18 is bent in a U-shape with the U-opening being disposed to be vertically oriented to the bottom. A carrying element 27, at which a carrying bolt 28 is rotatably accommodated via a bearing assembly 33, is located in the U-opening of the sheet metal support. The carrying bolt 28 has a hollow bore in order to lead another electrical connection 34 through the carrying bolt 28 such that the connection extends between the drive unit 5 and the wall element, which is accommodated at the carrying bolt 28.

The drive motor 13 may be disposed concentrically with regard to the drive shaft. At least at one side of the sheet metal support 18, space is thus made available for the second electrical unit 17, which might be configured in the shape of a printed circuit board, to be disposed laterally at a sheet metal support 18 within the drive unit 5. In the event of maintenance work, this offers the advantage of being able to service the second electrical unit 17, the drive motor 13 and the gear 23, 24 and to exchange them, if required, without having to uninstall the roller carriage 4 which runs in the guiding rail. The second electrical unit 17 serves at least for controlling the drive motor 13, wherein another electrical connection 34 passes through a cable conduit, located within the carrying bolt 28. Thereby another connection can be realized between the carriage unit 2 and a wall element.

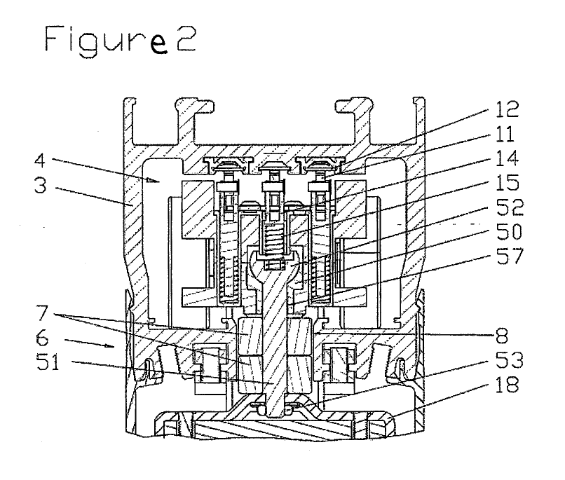

FIG. 2 shows a lateral view of the carriage unit 2, wherein at least the roller carriage 4 and the guiding device 6 are illustrated.

The suspension of the sliding wall at the roller carriage is realized via bolts 51 disposed to be pivotable in the roller carriage 4. For this purpose, the bolt 51 has an articulation 52 at one end, which is executed as a sphere in this embodiment. The bolt 51 may be integrally connected to the articulation 52, which allows for an inexpensive manufacturing as a turned part. However, the bolt 51 with the articulation 52 may consist of several separate components, whereby an optimized material configuration is possible. The articulation 52 may be supported directly in the lower roller carriage member 4b or in a separate insert 50 within the lower roller carriage member 4b. Again material pairings can be thus optimized with regard to wear behavior. At the other end, the bolt 51 has attachment elements for an attachment element 53, in order to be able to attach the sheet metal support 18 or another reception for the sliding wall. The sliding wall is thus suspended from the bolt 51 and can be pivoted with the bolt 51 at the articulation 52. The support of the bolt 51 in the roller carriage may be realized in this case, in that, in addition to the pivotable attachment of the wall element, likewise length compensation is possible. Delimiting the pivoting angle is realized by configuring, respectively by selecting the diameter of the bore 57, through which the bolt 51 extends into the roller carriage 4. Concerning the length, the bolt 51 is configured in that it can receive one or more guiding rollers 7.

In the embodiments of FIGS. 1 to 3, two guiding rollers 7 are illustrated on each bolt 51, which fact, when pivoting the sliding wall, contributes to minor canting within the guiding rail 3.

In order to support the guiding rollers 7, distance sleeves may be provided that act as a bearing. The guiding rollers 7 are separated from each other by buffer discs such as to allow for rotating in opposite directions.

Furthermore, the bolts 51 serve for a spring-loaded reception of a current collector 11. This collector is supported by two guiding pins 14, which are respectively accommodated in an associated bolt 51. The guiding pins 14 are loaded by spring elements 15 such as to be able to press the current collectors 11 against the power rail 12 located above the current collectors 11. On account of the double-stepped bores in the articulation 52, the guiding pins 14 and the spring elements 15 are separately accommodated whereby the construction height of the current collectors 11 is reduced.

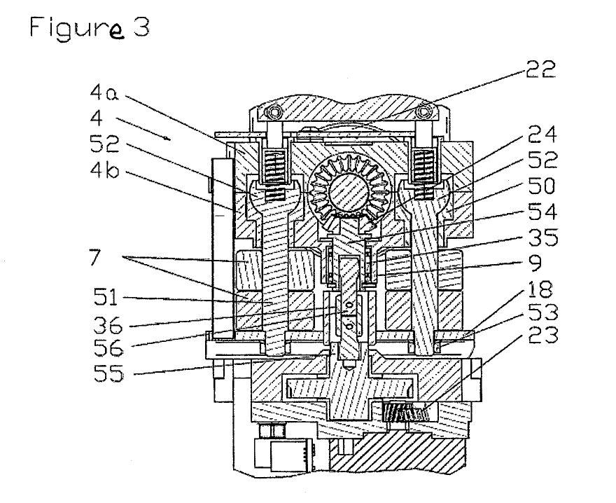

The sectional view of FIG. 3 reveals the driving train, which extends between the drive motor 13 and the roller carriage shaft 21. The drive motor 13 is disposed at a cylindrical gear system 23 from which a drive shaft extends vertically upwards into the roller carriage 4. An angular gear system 24 in the shape of a beveled toothing or crown toothing is configured at the drive shaft and the roller carriage shaft 21, such as to entrain the roller carriage shaft 21 and consequently the rollers 22 in a rotational movement by operating the drive motor 13. The drive shaft is rotatably supported in the lower roller carriage member 4b by a bearing 35. When laterally pivoting the sliding wall about the articulations 52, the transmission of forces by the angular gear 24 may continue to occur within a limited pivoting angle, because the gear compensates for angle errors in the meshing pinions. However, this is only possible with small pivoting angles.

For compensating larger pivoting angles, a pivotable coupling may be disposed between the cylindrical gear 23 and the angular gear 24 system. This coupling may consist of a coupling shaft 56, a lower coupling member 55 and an upper coupling member 54. In this case, the lower coupling member 55 is connected to the cylindrical gear 23. The upper coupling member 54 engages in the angular gear 24 and is supported in a bearing 35 in the intermediate web 9. Both coupling members 54, 55 are connected by the coupling shaft 56 disposed within a distance sleeve 36. The coupling may be configured as an angle-compliant coupling, such as a tooth coupling or as a universal coupling for example. Combining the articulated suspension of the sliding wall with the pivotable coupling allows the sliding wall to be pivotable, such as to compensate for any inaccuracy during installation of the running rail or any inaccuracy because of oblique ceiling structures.

The invention in its configuration is not limited to the above presented preferred embodiment. On the contrary, a number of variants is conceivable, which make use of the presented solution, even with basically different types of embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A drive system configured to drive and guide a wall element for a room partitioning wall system, comprising:
a guide rail;
a carriage unit guided to be longitudinally movable in the guide rail, the carriage unit is configured to pivotably support the wall element and comprises:
a roller carriage; and
a drive unit coupled to the roller carriage.

19. The drive system according to claim 18, wherein at least one articulation is disposed one of:
at the roller carriage for the pivotable attachment of the wall element and
in the roller carriage for the pivotable attachment of the wall element.

20. The drive system according to claim 19, wherein the wall element is one of:
directly attached to a sheet metal support and
indirectly attached to the sheet metal support,
wherein the sheet metal support is connected to the articulation.

21. The drive system according to claim 20, wherein the drive unit is disposed vertically below the roller carriage.

22. The drive system according to claim 21, wherein the roller carriage comprises at least one roller carriage shaft, wherein an angular gear system is disposed between the roller carriage shaft and the drive unit.

23. The drive system according to claim 21, wherein a guiding device that guides the carriage unit within the guiding rail is disposed between the roller carriage and the drive unit.

24. The drive system according to claim 23, wherein the guiding device comprises at least one guiding roller that guides the carriage unit and roll on guiding surfaces that laterally adjoin the guiding device.

25. The drive system according to claim 24, wherein the guiding roller is rotatably disposed on a bolt that connects the sheet metal support to the articulation.

26. The drive system according to claim 25, wherein at least two guiding rollers are disposed on the bolt.

27. The drive system according to claim 19, wherein the articulation is supported in an insert disposed one of at the roller carriage and in the roller carriage.

28. The drive system according to claim 22, wherein an output shaft of the drive unit is in pivotal engagement with the angular gear system.

29. The drive system according to claim 28, wherein a pivotable coupling is disposed between the output shaft of the drive unit and the angular gear system.

30. The drive system according to claim 18, wherein the guiding rail is affixed to the ceiling of a room and in that the drive motor extends in vertical direction underneath the guiding rail.

31. The drive system according to claim 20, wherein the sheet metal support is U-shaped and is disposed with its U-opening being oriented vertically downwards, wherein a cylindrical gear system is disposed in the sheet metal support.

32. The drive system according to claim 31, wherein the drive motor is disposed laterally offset within the sheet metal support and is mechanically connected to the cylindrical gear system.

33. The drive system according to claim 18, wherein the roller carriage has a roller carriage shaft with two rollers, wherein one of the rollers is driven on one side of the roller carriage and the other roller, disposed on an opposite side of the roller carriage, is supported to be freely moving.

34. The drive system according to claim 18, wherein the roller carriage has two roller carriage shafts each with respectively two rollers, wherein two of the rollers are driven on one side of the roller carriage and the two rollers, disposed on an opposite side, are supported to be freely moving.
